(19) United States
(12) Patent Application Publication
(10) Pub. No.: US 2022/0416252 A1
(43) Pub. Date: Dec. 29, 2022

(54) ELECTRODE FOR METAL HYDROGEN BATTERY AND METHOD FOR MANUFACTURING SAME

(71) Applicant: EnerVenue Inc., Fremont, CA (US)

(72) Inventors: Ge Zu, San Jose, CA (US); Yingying Wu, Sunnyvale, CA (US); Jingyi Zhu, San Jose, CA (US); Michael J. Kenney, San Francisco, CA (US); Majid Keshavarz, Pleasanton, CA (US)

(21) Appl. No.: 17/847,591

(22) Filed: Jun. 23, 2022

Related U.S. Application Data
(60) Provisional application No. 63/214,514, filed on Jun. 24, 2021.

(51) Int. Cl. H01M 4/62; H01M 4/38; H01M 4/24

(52) U.S. Cl. CPC H01M 4/625; H01M 4/383; H01M 4/242

(57) ABSTRACT

Electrodes for a metal-hydrogen battery are described. The electrodes include one or more porous layers, each of the porous layers including a porous substrate and a catalyst layer covering the porous substrate, the catalyst layer including a transition metal, wherein at least one of the at least one porous layer includes a surface with features that facilitate hydrogen gas transport. In some embodiments, an anode electrode includes a first porous layer having a first surface; and a second porous layer adjacent the first porous layer having a second surface, wherein the first surface of the first porous layer and the second surface of the second porous layer form hydrogen gas transport channels.

### RELATED APPLICATIONS

This disclosure is related to and claims priority to U.S. Provisional Application 63/214,514, filed on Jun. 24, 2021, which is herein incorporated by reference in its entirety.

### TECHNICAL FIELD

This disclosure is generally related to metal hydrogen batteries and methods for manufacturing those batteries, and more particularly to anode electrodes used in a metal hydrogen batteries and methods for manufacturing the anode electrodes.

### BACKGROUND

For renewable energy resources such as wind and solar to be competitive with traditional fossil fuels, large-scale energy storage systems are needed to mitigate their intrinsic intermittency. To build a large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid storage. Rechargeable batteries offer great opportunities to target low-cost, high capacity and highly reliable systems for large-scale energy storage.

### SUMMARY

Described herein are electrodes for metal-hydrogen batteries and methods for making the electrodes and the batteries. In some embodiments, an electrode for a metal-hydrogen battery includes one or more porous layers, each of the porous layers including a porous substrate and a catalyst layer covering the porous substrate, the catalyst layer including a transition metal, wherein at least one of the at least one porous layer includes a surface with features that facilitate hydrogen gas transport. In some embodiments, an anode electrode includes a first porous layer having a first surface; and a second porous layer adjacent the first porous layer having a second surface, wherein the first surface of the first porous layer and the second surface of the second porous layer form transport channels.

In some embodiments, an anode electrode includes a first porous layer having a first surface; and a second porous layer adjacent the first porous layer having a second surface, wherein the first surface of the first porous layer and the second surface of the second porous layer form transport channels.

In some embodiments, a battery is presented. The battery includes a pressure vessel; and an electrode stack positioned in the pressure vessel, the electrode stack holding electrolyte, wherein the electrode stack includes alternately stacked cathode electrodes and anode electrodes separated by a separators, the anode electrode including one or more porous layers, each of the porous layers including a porous substrate and a catalyst layer covering the porous substrate, the catalyst layer including a transition metal, wherein at least one of the at least one porous layer includes a surface with features that facilitate hydrogen gas transport.

In some embodiments a method for forming an electrode for a metal-hydrogen battery, the method including obtaining one or more porous substrates; forming surface features in at least one surface of at least one of the porous substrates; coating the one or more porous substrates with a catalyst layer to form porous layers; and connecting the porous layers to form the electrode.

Other embodiments are contemplated and explained herein after.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIGS. 1A, 1B, and 1C depict a schematic of a metal-hydrogen battery that can include embodiments of electrodes according to the present disclosure.

FIG. 2 illustrates a cross-section view of an electrode having a single-layer structure according to some embodiments of the present disclosure.

FIG. 3A illustrates a cross-section view of an electrode having a double-layer structure according to some embodiments of the present disclosure.

FIG. 3B illustrates a cross-section view of an electrode having another double-layer structure according to some embodiments of the present disclosure.

FIG. 3C illustrates a cross-section view of an electrode having a three-layer structure according to some embodiments of the present disclosure.

FIG. 4 depicts a porous substrate coated with a catalyst layer according to some embodiments of the present disclosure.

FIG. 5 depicts a method for forming an electrode for a metal-hydrogen battery according to some embodiments of the present disclosure.

FIG. 6 depicts an embodiment of the method for forming an electrode for a metal-hydrogen battery as illustrated in FIG. 5.

FIG. 7 depicts an embodiment of the method for forming an electrode for a metal-hydrogen battery as illustrated in FIG. 5.

FIG. 8 depicts an embodiment of the method for forming an electrode for a metal-hydrogen battery as illustrated in FIG. 5.

FIG. 9 depicts an embodiment of the method for forming an electrode for a metal-hydrogen battery as illustrated in FIG. 5.

FIGS. 10A-D are scanning electron microscopic (SEM) images showing that surfaces of electrodes according to some embodiments with higher double layer capacitance (C_{dl}) values have rougher surfaces.

FIG. 11A shows a consistent catalyst loading achieved by using a plating bath with higher metal concentration, according to some embodiments of the present disclosure.

FIG. 11B is a diagram showing capacity vs. voltage curves of three battery cells, according formed with electrodes according to some embodiments of the present disclosure.

FIG. 11C is a diagram showing efficiency vs. cycle number curves of three battery cells, according to one example embodiment.

FIG. 12A is an image of a porous layer showing a corrugated surface feature, according to some embodiments of the present disclosure.

FIG. 12B is an SEM image showing a porous substrate before a compression process according to some embodiments of the present disclosure.

FIG. 12C is an SEM image showing a porous substrate after a compression, according to some embodiments of the present disclosure.

FIG. 12D is a diagram illustrating voltage-capacity curves for a 10 Ah battery using a three-layer electrode according to some embodiments of the present disclosure.

FIG. 13A is a diagram showing that a battery cell with an electrode that has not been coated with a surface-affinity modification (e.g., a wet-proofing coating) according to some embodiments.

FIG. 13B is a diagram showing that a battery cell after a wet-proofing coating step according to some embodiments of the present disclosure, which exhibits significantly improved discharge characteristics over that of the battery cell shown in FIG. 13A.

FIG. 14 illustrates stable cycling of a battery having electrodes according to some embodiments.

FIG. 15 illustrates voltage versus capacity of batteries that are cycling at a wide range of charging rates (C-rates) using electrodes according to some embodiments.

FIG. 16 illustrates long-term cycle performance of another battery having electrodes according to some embodiments.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Embodiments of the present disclosure describes an electrode for a metal-hydrogen battery formed from one or more porous layers. Each of the porous layers includes a porous substrate and a catalyst layer covering the porous substrate, the catalyst layer including a transition metal. At least one of the one or more porous layer includes a surface with features that facilitate hydrogen gas transport. In some embodiments, an anode electrode includes a first porous layer having a first surface; and a second porous layer adjacent the first porous layer having a second surface, wherein the first surface of the first porous layer and the second surface of the second porous layer form hydrogen gas transport channels.

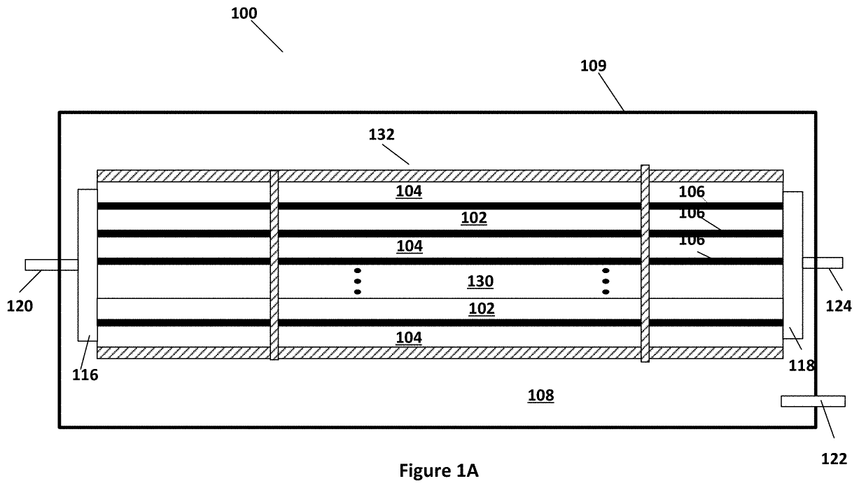

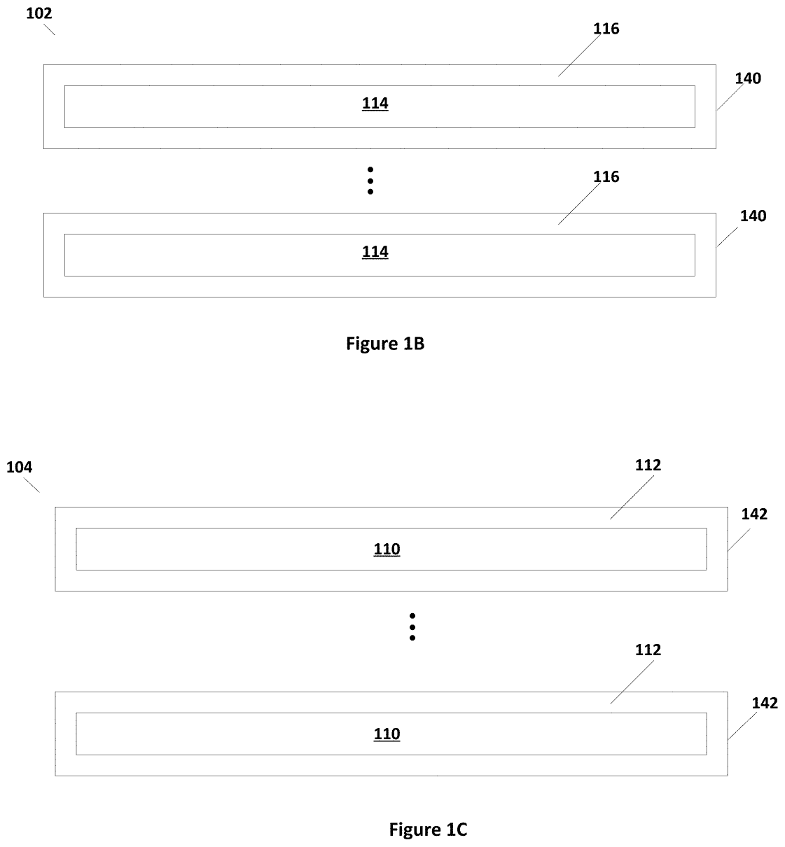

FIG. 1A depicts a schematic depiction of an individual pressure vessel (IPV) metal-hydrogen battery 100 in which embodiments of the present disclosure can be used. The metal-hydrogen battery 100 includes electrode stack assembly 130 that includes stacked electrodes that are separated by separators 106. The electrode stack assembly 130 includes alternately stacked cathode electrodes 102 and anode electrodes 104 as illustrates in FIG. 1A. Cathode electrodes 102 and anode electrodes 104 are separated by separators 106 that are disposed between them. Separator 106 can be saturated with an electrolyte 108. In some embodiments, separator 106, in addition to electrically separating cathode electrodes 102 from anode electrodes 104, provides a reservoir of electrolyte 108 that buffers the electrodes from either drying out or flooding during operation of battery 100.

As illustrated in FIG. 1A, the electrode stack assembly 130 can be housed in a pressure vessel 109. As illustrated, an electrolyte 108 is disposed in pressure vessel 109 such that stack 130 is saturated with electrolyte 108. The cathode electrode 102, the anode electrode 104, and the separator 106 are porous to hold electrolyte 108 and allow ions in electrolyte 108 to transport between the cathode electrodes 102 and the anode electrodes 104. In some embodiments, the separator 106 can be omitted as long as the cathode electrodes 102 and the anode electrodes 104 can be electrically insulated from each other and sufficient electrolyte 108 can be held in electrode stack 130. For example, the space occupied by the separator 106 may be filled with the electrolyte 108.

The metal-hydrogen battery 100 illustrated in FIG. 1A can further include a fill tube 122 configured to introduce electrolyte or gasses (e.g. hydrogen) into pressure vessel 109. Fill tube 122 may include one or more valves (not shown) to control flow into and out of the enclosure of pressure vessel 109 or fill tube 122 may be otherwise sealable after charging pressure vessel 109 with electrolyte 108 and hydrogen gas.

As shown in FIG. 1A and discussed above, electrode stack assembly 130 includes a number of stacked layers of alternating cathode electrodes 102 and anode electrodes 104 separated by separators 106. Although the electrodes in an electrode stack assembly 130 may be coupled either in parallel or in series, in the example of battery 100 illustrated in FIG. 1A the electrodes are coupled in parallel. In particular, each of cathode electrodes 102 are coupled to a conductor 118 and each of anode electrodes 104 are coupled to conductor 116. Although FIG. 1A illustrates that fill tube 122 is positioned on the side of conductor 118, fill tube 122 may alternatively be placed on the side of conductor 116, or otherwise placed anywhere on pressure vessel 102.

As is further illustrated in FIG. 1A, conductor 116, which is coupled to anode electrodes 104, is electrically coupled to feedthrough terminal 120, which may present one terminal of battery 100. Terminal 120 can include a feedthrough to allow terminal 120 to extend outside of pressure vessel 102, or conductor 116 may be connected directly to pressure vessel 109, especially because terminal 120 is coupled to the anode electrodes 104. Similarly, conductor 118, which is coupled to cathode electrodes 102, can be coupled to a feedthrough terminal 124 that represents the opposite (positive) terminal of battery 100. Terminal 124 also pass through an insulated feedthrough to allow terminal 124 to extend to the outside of pressure vessel 109, because terminal 124 is coupled to the cathode electrodes 104.

As is illustrated in FIG. 1A, electrode stack 104 can be fixed within a frame 132. In FIG. 1A electrode stack assembly 130 can be organized with anode electrodes 104 on both sides adjacent to frame 132, in order to isolate cathode electrodes 102 from frame 132. In some embodiments, a separator 106 can be included adjacent to frame 132 for further isolation, especially if electrode stack assembly 130 is arranged such that cathode electrodes 102 are adjacent to frame 132 rather than anode electrodes 104.

As discussed above, electrode stack 130 includes alternating layers of cathode electrodes 102 and anode electrodes 104 that are separated by separators 106. Electrode stack assembly 130 is positioned in pressure vessel 109 and contains an electrolyte 108 where ions in electrolyte 108 can transport between cathode electrodes 102 and anode electrodes 104. Separator 106 can be a porous insulator. In some embodiments, the electrolyte 108 is an aqueous electrolyte that is alkaline (with a pH greater than 7).

FIG. 1B illustrates some embodiments of cathode electrode 102. Cathode electrode 102 can include one or more cathode porous layers 140, each of the porous layers 140 formed of a conductive substrate 114 covered with a coating 116. Coating 116 can be a redox-reactive material that includes a transition metal, as is discussed further below. Similarly, as illustrated in FIG. 1C, anode electrode 104 can include one or more anode porous layers 142, each of the anode porous layers 142 including a porous conductive substrate 110 coated with a catalyst layer 112, which is further discussed below. Consequently, as illustrated in FIGS. 1B cathode electrode 102 can be formed from one or more cathode porous layers 140 and as illustrated in FIGS. 1C anode electrode 104 can be formed from one or more anode porous layers 142.

In some embodiments, the anode electrode 104 is a catalytic hydrogen electrode. As shown in FIG. 1C, in some embodiments, the anode electrode 104 includes stacks of porous layers 142, each porous layer 142 including a porous conductive substrate 110 and a catalyst layer 112 covering the porous conductive substrate 110. The catalyst layer 112 can include a bi-functional catalyst to catalyze both hydrogen evolution reaction (HER) and hydrogen oxidation reaction (HOR) at the anode electrode 104. In some embodiments, the porous conductive substrate 110 has a porosity of at least about 10%, at least about 20%, at least about 30%, at least about 40%, or at least about 50%, and up to about 80%, up to about 90%, 95% or greater. In some embodiments, the porous conductive substrate 110 can be a metal foam, such as a nickel foam, an iron foam, a copper foam, a steel foam, or others. In some embodiments, the porous conductive substrate 110 is metal alloy foam, such as a nickel-molybdenum foam, a nickel-iron foam, a nickel-copper foam, a nickel-cobalt foam, a nickel-tungsten foam, a nickel-silver foam, a nickel-molybdenum-cobalt foam, or others. Porous conductive substrate 110 can be formed of other conductive substrates, for example metal foils, metal meshes, and fibrous conductive substrates. In some embodiments, the conductive substrate 110 can be formed of carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam.

In some embodiments, the bi-functional catalyst of the catalyst layer 112 can be a nickel-molybdenum-cobalt (NiMoCo) alloy. Other transition metal or metal alloys can be bi-functional catalysts, for example nickel, nickel-molybdenum, nickel-tungsten, nickel-tungsten-cobalt, nickel-tungsten-copper, nickel-carbon, nickel-chromium, based composites. In some embodiments, bi-functional catalyst of catalyst layer 112 can include a transition metal alloy that includes two or more of Ni, Co, Cr, Mo, Fe, Mn, Cu, Zn, Sn, and W. Other precious metals and their alloys can also be included in bi-functional catalysts, for example platinum, palladium, iridium, gold, rhodium, ruthenium, rhenium, osmium, silver, and their alloys with precious and non-precious transition metals such as platinum, palladium, iridium, gold, rhodium, ruthenium, rhenium, osmium, silver, nickel, cobalt, manganese, iron, molybdenum, tungsten, chromium and so forth. In some embodiments, bi-functional catalysts of catalyst layer 112 can be a combination of HER and HOR catalysts. In some embodiments, the bi-functional catalysts of catalyst layer 112 can include a mixture of different materials, such as transition metals and their oxides/hydroxides, which contribute to hydrogen evolution and oxidation reactions as a whole. In some embodiments, the catalyst layer 112 includes nanostructures of the bi-functional catalyst having sizes (or an average size) in a range of, for example, about 1 nm to about 100 nm, about 1 nm to about 80 nm, or about 1 nm to about 50 nm. In some embodiments, the catalyst layer 112 includes microstructures of the bi-functional catalyst having sizes (or an average size) in a range of, for example, about 100 nm to about 500 nm, about 500 nm to about 1000 nm.

In some embodiments, the anode electrode 104 may be a single-layer structure or a multilayer structure, as is illustrated above with FIG. 1C. In some embodiments, anode electrode 104 can be formed with flat or with uneven surfaces, or multiple layers can be formed with a combination of flat and uneven circumstances surfaces. Embodiments of the present disclosure includes at least one porous layer 142 that with a surface having features resulting in an uneven surface.

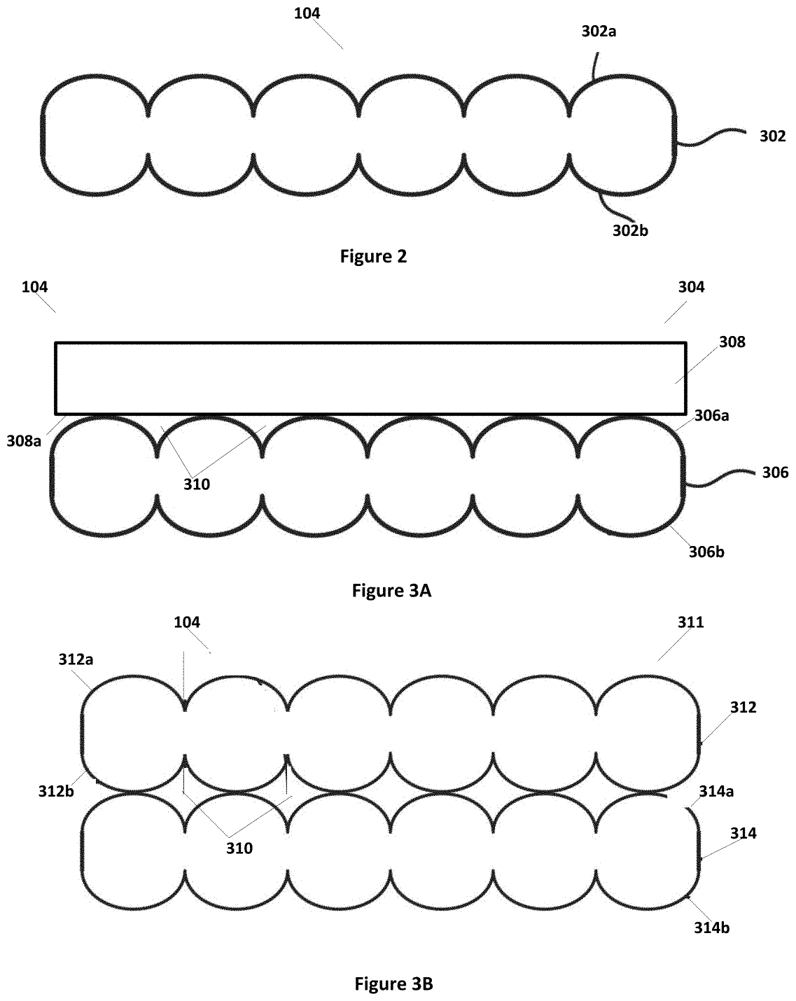

FIG. 2 illustrates a cross-section view of an embodiment of anode electrode 104 having a single-layer porous layer 302. The single-layer porous layer 302 includes an uneven upper surface 302a and a lower surface 302b. Upper surface 302a and lower surface 302b can be formed with different features. The uneven surfaces 302a and 302b can increase surface reaction sites for HER and HOR, facilitate hydrogen gas transportation to and away from the surface of anode electrode 104, and improve the performance of the anode electrode 104. The uneven surfaces 302a and 302b may be symmetrical or asymmetrical. In some embodiments, the uneven surfaces 302a and 302b of the single-layer structure 302 may be formed by pressing or stamping a cuboid substrate against electrode porous substrate 110 to create a desired surface contour. In some embodiments, the features of surface 302a may include, for example, a corrugated surface. In some embodiments, the features of surfaces 302b may be smooth or flat or may also be corrugated. The formation of features on surfaces 302a and 302b may be accomplished prior to application of catalytic coating 112, or in some embodiments may be accomplished after catalytic coating 112. As shown in FIG. 2, the features of uneven surfaces 302a and 302b may be corrugated surfaces according to one example embodiment. Other surface contour features may also be formed. For example, the surfaces 302a and 302b may include rounded hills and/or valleys, notches, corrugation, or other features. In some embodiments, one of the surfaces 302a and 302b may be configured to be flat or smooth. As described below with respect to FIG. 2, the single-layer structure 302 may include a porous substrate 110 formed of metal or metal alloy foam. The surface contour (e.g., corrugated surfaces or other featured surfaces) of the single-layer structure 302 in FIG. 2 is illustrated in a macroscopic view. In a microscopic view, the surface of the single-layer structure 302 includes a plurality of micro and/or nano pores.

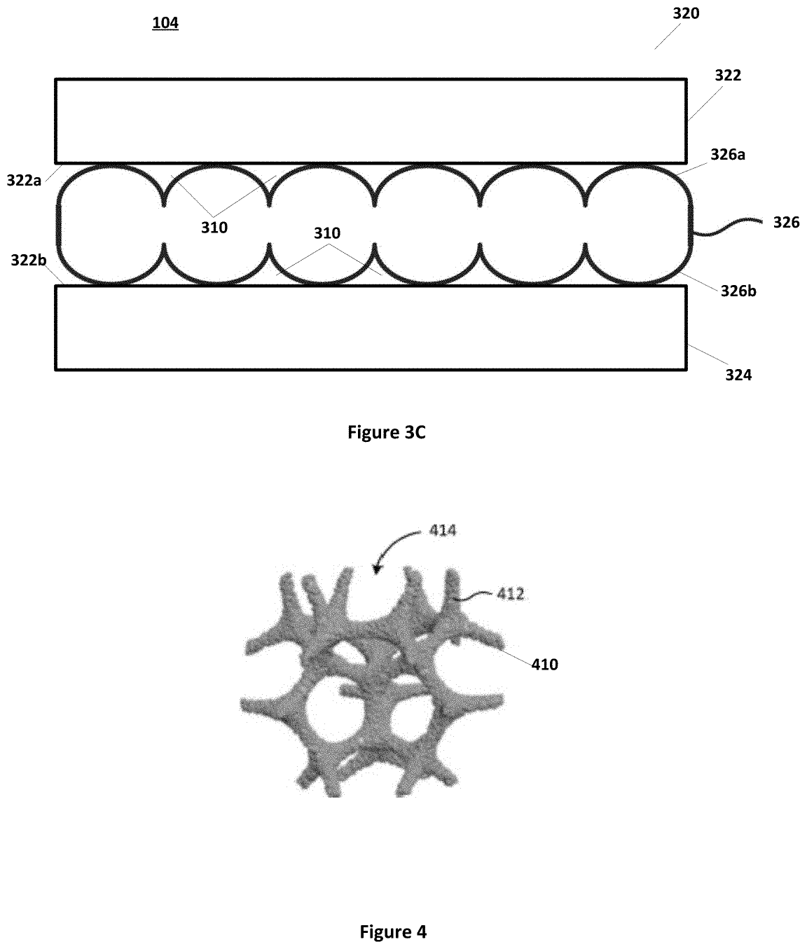

Embodiments of anode electrode 104 according to some embodiments includes any number (one or more) of porous layers 142 where at least one porous layer 142 includes a surface with uneven features. These uneven features can be formed by pressing or stamping the porous conductor 110 of that porous layer 142. The uneven surface can include features such as corrugation, rounded hills, notches, grooves, or other shapes that cause the surface topology to be uneven. FIGS. 3A through 3C illustrates a few embodiments of anode electrode 104. However, it should be understood that any stacking of porous layers 142 that create channels that facilitate hydrogen gas flow can be used. For example, FIG. 2 illustrates a single layer anode electrode 104 with, for example, corrugated surfaces. FIG. 3A illustrates an embodiment of anode electrode 104 having two porous layers 142, FIG. 3B illustrates another embodiment of anode electrode 104 with two porous layers 142, and FIG. 3C illustrates an embodiment of anode electrode 104 with three porous layers 142. However, embodiments of anode electrode layer 104 can include more than three layers as well.

FIG. 3A illustrates a cross-section view of an anode electrode 104 having a double-layer structure 304 (i.e. two porous layers 142), according to some embodiments. The double-layer structure 304 of anode electrode 104 includes a first porous layer 306 and a second porous layer 308 stacked adjacent to each other. In the illustrated embodiment, the first porous layer 306 is similar to the single-layer structure 302 illustrated in FIG. 2 and includes an unevenly featured upper surface 306a and a lower surface 306b. The second porous layer 308 is configured to have smooth and flat surfaces (e.g., the lower surface 308a is smooth/flat). The configurations of the first porous layer 306 adjacent to the second layer 308 creates a plurality of channels 310 between the surface 306a and the surface 308a, depending on the features formed in surface 306a of porous layer 306. For example, a corrugated porous layer 306 forms channels 310. Channels 310 can be formed with other features as well as discussed above. As discussed above, channels 310 can facilitate the movements of hydrogen gas during the HOR and HER. In some embodiments, the porosity of the first porous layer 306 and the second porous layer 308 may also be different. As described below with respect to FIG. 4, each of the first layer 306 and the second layer 308 may include a porous substrate 110 (e.g., metal or alloy foam) coated with a catalyst layer 112. The flat or uneven surfaces of the first layer 306 and the second layer 308 in FIG. 3A are illustrated in a macroscopic view. In a microscopic view, the surfaces include a plurality of micro and/or nano pores.

In some embodiments, channels may also be created by stacking two porous layers 142, each with uneven surface features between different layers. An embodiment of anode electrode 104 that illustrates this embodiment is shown in FIG. 3B. FIG. 3B illustrates a cross-section view of an anode electrode 104 having a double-layer structure 311 (two porous layers 142) according to some embodiments. The double-layer structure 311 includes a first porous layer 312 and a second porous layer 314 stacked adjacent to each other. As illustrated in FIG. 3B, both of the first porous layer 312 and the second porous layer 314 of anode electrode 104 are similar to the single-layer structure 302 illustrated in FIG. 2. The first porous layer 312 includes an upper surface 312a and an uneven lower surface 312b. The second porous layer 304 includes an uneven upper surface 314a and a lower surface 314b. Upper surface 312a and lower surface 314b may themselves include uneven features or may be flat or smooth. The configurations of the first porous layer 312 and the second porous layer 314 creates a plurality of channels 310 between the surface 312b of the first porous layer 312 and the surface 314a of the second porous layer 314. These channels 310 can facilitate the movements of hydrogen gas during the HOR and HER. Other configurations of the first porous layer 312 and the second porous layer 314 are contemplated as long as the channels can be created at their interface when the first porous layer 312 and the second porous layer 314 are stacked. In some embodiments, the porosity of the first porous layer 312 and the second porous layer 314 may be different. As described below with respect to FIG. 4, each of the first porous layer 312 and the second porous layer 314 may include a porous substrate 110 (e.g., metal or metal alloy foam) and a catalyst layer 112 covering the porous substrate 110. The uneven surfaces of the first porous layer 312 and the second porous layer 314 in FIG. 3B are illustrated in a macroscopic view. In a microscopic view, the surfaces include a plurality of micro and/or nano pores.

FIG. 3C illustrates a cross-section view of an anode electrode 104 having a three-layer structure 320 (i.e. three porous layers 142) according to some embodiments. The three-layer structure 320 includes a first porous layer 322, a second porous layer 324, and a third porous layer 326 interposed between the first porous layer 322 and the second porous layer 324. The first porous layer 322, the second porous layer 324, and the third porous layer 326 have a first porosity, a second porosity, and third porosity, respectively, where the third porosity may be the same, smaller, or greater than the first porosity and the second porosity.

In some embodiments, the surface contours of the first porous layer 322, the second porous layer 324, and the third porous layer 326 are configured such that when they are stacked together, a plurality of channels 310 are created at the interfaces between the first porous layer 322 and the third porous layer 326 (e.g., first channels), and between the second porous layer 324 and the third porous layer 326 (e.g., second channels). These channels 310 can facilitate the movements of hydrogen gas during the HOR and HER. In the illustrated embodiment shown in FIG. 3C, a surface 322a of the first porous layer 322 facing the third porous layer 326 can be configured to be smooth and flat while a surface 326a of the third porous layer 326 facing the surface 322a is configured to be uneven (e.g., corrugated, notched, rounded hills and/or valleys, grooves, or other features) such that at least one channel 310 is formed therebetween. Further, a surface 324a of the second porous layer 324 facing the third porous layer 326 can be configured to be smooth and flat while a surface 326b of the third porous layer 326 facing the surface 324a is configured to be uneven (e.g., corrugated, notched, or including other such features) such that at least one channel 310 is formed therebetween.

It should be understood that the embodiments shown in FIGS. 2 and 3A-3C are merely illustrative and not limiting. Other configurations are contemplated. For example, each of the embodiments shown in FIGS. 2 and 3A-3C may include additional porous layers 142. Further, although the surfaces 326a and 326b are shown as corrugated, other surface contours can be used if the surface contours can facilitate creation of gas channels at the interfaces. In some embodiments, at least one of the surfaces 322a and 326a is uneven such that at least one gas channel can be created therebetween, and/or at least one of the surfaces 324a and 326b is uneven such that at least one gas channel can be created therebetween. In some embodiments, the contours of the surfaces 322a and 326a are configured to be different from each other such that at least one gas channel can be created therebetween, and/or the contours of the surfaces 324a and 326b are configured to be different from each other such that at least one gas channel can be created therebetween. Further, although the anode electrode 104 is illustrated to have three porous layers, this disclosure is not limited to this structure. For example, the anode electrode 104 may include a top stacking of two first porous layers 322, a bottom stacking of two second porous layers 324, and one or more third porous layer 326 interposed between the top stacking and the bottom stacking. In some embodiments, a gas diffusion layer may be disposed between the first porous layer 322 and the third porous layer 326, and/or between the second porous layer 324 and the third porous layer 326. For example, a gas diffusion layer may be porous.

In some embodiments, the first porous layer 322 and the second porous layer 324 may be configured such that they have uneven (e.g., corrugated, notched, or including other features) surfaces similar to surfaces 326a and 326b of the third porous layer 326. The corrugated surfaces of two adjacent layers are arranged to face each other to create channels 310. In some embodiments, the anode electrode 104 may consist of any one or any two of the first porous layer 322, the second porous layer 324, and the third porous layer 326.

In some embodiments, to create different affinities with respect to the electrolyte (e.g., electrolyte 108) in the porous layers 142, at least one of the catalyst layers in anode electrode 104 may be partially coated with a surface-affinity modification material. For example, in structure 320 illustrated in FIG. 3C, at least one of porous layers 322, 324, and 326 is coated with a surface-affinity modification material. When the catalyst layers on the porous substrates 142 are hydrophilic to the electrolyte, the catalyst layers 112 may be partially coated with a material that is hydrophobic to the electrolyte 108. On the contrary, when the catalyst layers 112 on the porous substrates are hydrophobic to the electrolyte, the catalyst layers may be partially coated with a material that is hydrophilic to the electrolyte. This structure can facilitate movement of hydrogen gas in the pores of the electrode and improve HOR during discharge.

With reference to FIG. 4, in some embodiments, each of the first porous layers 142 (or the layer structures illustrated in FIGS. 2, 3A, and 3B) includes a porous substrate 410 and a catalyst layer 412 coated on the porous substrate 410, wherein the catalyst layer 412 includes a transition metal alloy. The porous substrate 410 is similar to the porous conductive substrate 110 of FIG. 1C and may include a metal foam or a metal alloy foam as explained above. The catalyst layer 412 is similar to the catalyst layer 112 of FIG. 1C. As such, the surface contours in FIGS. 2 and 3A-3C are illustrated in macroscopic views. Each of those surfaces includes a plurality of micro and/or nano pores 414 as shown in FIG. 4.

As discussed above, catalyst layers 112 can include transition metal or metal alloy catalysts. Further, a polymer material may be coated on the catalyst layers to provide wet-proofing effect to avoid anode flooding where the pores in the anode are filled with electrolyte. In some embodiments, the polymer material includes polyethylene, polypropylene, partial or fully fluorinated polymers such as polytetrafluoroethylene (PTFE), fluorinated ethylene propylene (FEP), polyethylenetetrafluoroethylene (ETFE), polyvinylfluoride (PVF), polyvinylidene fluoride (PVDF), and other fluorinated polymers. While the electrode for the metal-hydrogen battery may be coated with a surface-affinity modification material, the surface-affinity modification material is not configured to cover the entire surface of the catalyst layer. For example, the surface-affinity modification material may cover up to 1%, 5%, 10%, 20%, 30%, 40%, 50%, 60%, or 70% of the entire surface of the catalyst layer.

Referring back to FIG. 1B, the cathode electrode 102 may include a conductive substrate 114 and a coating 116 covering the conductive substrate 114. The coating 116 includes a redox-reactive material that includes a transition metal. In some embodiments, the conductive substrate 114 is porous, such as having a porosity of at least about 10%, at least about 20%, at least about 30%, at least about 40%, or at least about 50%, and up to about 80%, up to about 90%, or greater. In some embodiments, the conductive substrate 114 can be formed of a metal foam, such as a nickel foam, or a metal alloy foam. Other conductive substrates are encompassed by this disclosure, such as metal foils, metal meshes, and fibrous conductive substrates. In some embodiments, the transition metal included in the redox-reactive material is nickel. In some embodiments, nickel is included, for example as nickel hydroxide or nickel oxyhydroxide. In some embodiments, the transition metal included in the redox-reactive material can be cobalt. In some embodiments, cobalt is included as cobalt oxide or zinc cobalt oxide. In some embodiments, the transition metal included in the redox-reactive material can be manganese. In some embodiments, manganese can be included as manganese oxide or doped manganese oxide (e.g., doped with nickel, copper, bismuth, yttrium, cobalt or other transition or post-transition metals). Other transition metals are encompassed by this disclosure, such as silver. In some embodiments, the coating microstructures of the redox-reactive material, may have sizes (or an average size) in a range of, for example, about 1 μm to about 100 μm, about 1 μm to about 50 μm, or about 1 μm to about 10 μm.

In some embodiments, the electrolyte 108 is an aqueous electrolyte. The aqueous electrolyte is alkaline and has a pH greater than 7, such as about 7.5 or greater, about 8 or greater, about 8.5 or greater, or about 9 or greater, or about 11 or greater, or about 13 or greater. As a non-limiting example, the electrolyte 108 may include KOH or NaOH or LiOH or a mixture of LiOH, NaOH and/or KOH.

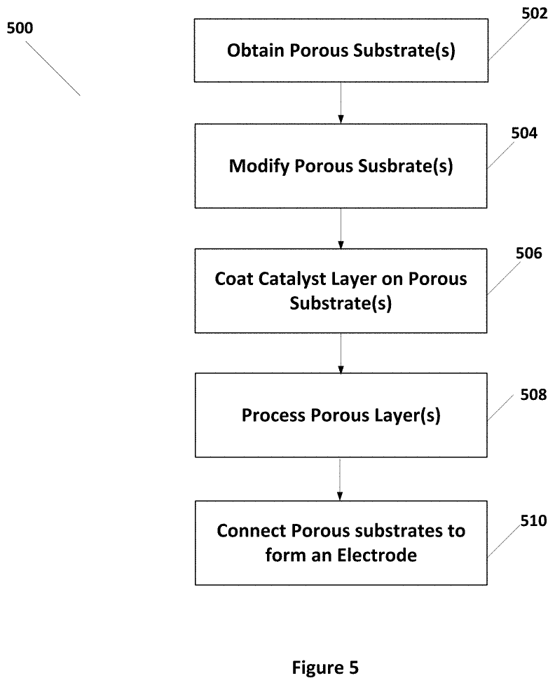

FIG. 5 illustrates an embodiment of a method 500 of forming embodiments of anode electrode 104. At step 502, one or more porous substrates 110 are obtained. The number of porous substrates 110 processed determines the number of porous layers 142 in anode electrode 104. The porous substrates 110, as discussed above, may be conductive. In some embodiments, a metal foam, such as a nickel foam, a copper foam, an iron foam, a steel foam, an aluminum foam, etc., may be adopted to form the porous substrates 110. In some embodiments, the porous substrate 110 is a metal alloy foam including nickel, such as a nickel-iron foam, a nickel-molybdenum foam, a nickel-copper foam, a nickel-cobalt foam, a nickel-tungsten foam, a nickel-silver foam, a nickel-molybdenum-cobalt foam, etc. As discussed above, porous substrate 110 can also be formed of other materials, such as porous metal foils, metal meshes, and fibrous conductive substrates. Further, in some embodiments the porous substrates 110 can be formed of carbon-based materials, such as carbon fibrous paper, carbon cloth, carbon felt, carbon mat, carbon nanotube film, graphite foil, graphite foam, graphite mat, graphene foil, graphene fibers, graphene film, and graphene foam. The porous substrates 110 may have a porosity of at least about 10%, at least about 20%, at least about 30%, at least about 40%, or at least about 50%, and up to about 80%, up to about 90%, or greater. Porous substrates 110 having different porosities may be utilized.

In step 504, the porous substrate 110 maybe modified. Modification of porous substrate 110 can occur in a number of ways, including adjusting the surface morphology of porous substrate 110, adjusting the porosity of the porous substrate 110, other processes, and various combinations of these processes. Some of the processes that may be performed in modification step 504 are discussed further below. Additionally, if there are multiple porous substrates 110 being processed, the processing performed on each individual porous substrate 110 in modification step 504 may be different from each other.

At step 506, each of the porous substrates prepared in modification step 504 are coated with a catalyst layer 112, for example by electroplating. The catalyst layer 112 can include two or more transition metals such as Ni, Co, Cr, Mo, Fe, Zn, Sn, and W. In some embodiments, the catalyst layer 112 includes a nickel-molybdenum-cobalt (NiMoCo) alloy or another alloy as discussed above. In some embodiments, the entire surface of the porous substrate is coated with the catalyst layer 112. In some implementations, the catalyst layer 112 may not cover the entire surface of the porous substrate 110. In the electroplating process, the electroplating can be conducted in a bath that includes the transition metals to form the catalyst layer. In some embodiments, the plating bath can be a solution of salts of Nickel, Molybdenum, Cobalt, etc., with concentrations in the range of 0.1 to 100 g/liter (grams/liter). The solution of the plating bath can also have a pH buffer salt like Sodium Bicarbonate with concentration in the range of 1-100 g/liter, and sometimes other salts like Sodium Pyrophosphorous with concentrations 1-100g/liter, to help stabilize the solution of the plating bath.

Deposition of the catalyst layer 112 in step 506 can also be carried out via chemical reduction methods or physical vapor deposition (PVD) methods, such as sputtering, electron beam deposition, or chemical vapor deposition (CVD), atomic layer deposition (ALD), or other methods. Further, as discussed above, the catalyst can be a bi-functional catalyst as described above.

In step 508, the porous layers 142 that were produced in step 506 are further processed. Such processing may include, for example, a leaching process, an annealing process, surface-affinity coating (wet proofing), other processes, and any combination of these processes. Additionally, if there are multiple porous layers 142 being processed, the processing performed on each individual porous layer 142 may be different from each other.

At step 510, one or more porous layers 142, each coated with the catalyst layer resulting from step 508, are connected/coupled to each other to form an anode electrode 104 for a metal-hydrogen battery 100. The resulting anode electrode 104 can be those discussed above with respect to FIGS. 2 and 3A through 3C. As is illustrated in FIGS. 3A through 3C, each of the porous layers 104 that are connected in step 508 may have undergone different processing in method 508.

It should further be understood that although the operations 502-510 are illustrated in a particular sequence in FIG. 5, this disclosure is not so limited. The operations 502-510 may be performed in a different orders to form same or similar electrodes. FIG. 5 is for illustration purposes and is not intended to be limiting as to the order of operations.

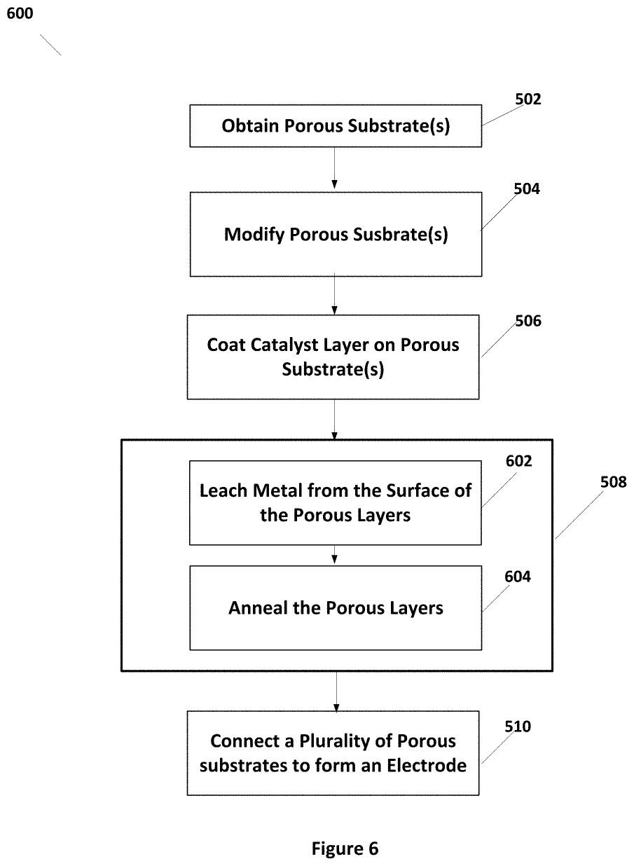

FIGS. 6-9 illustrate various embodiments of method 500. Although each of FIGS. 6-9 illustrate various individual processes, it is understood that method 500 used to produce a particular embodiment of anode electrode 104 can include any combination, or all, of the processes discussed here.

FIG. 6 depicts a method 600 that is an example of method 500 for forming an anode electrode 104 for a metal-hydrogen battery 100. As discussed above, at step 502 one or more porous substrates 110 are obtained. At step 504, each of the porous substrates 110 can be modified. In step 506, the modified porous substrates 110 are coated with a catalyst layer 112, for example by electroplating, to form porous layers 142. At step 508, the porous layers 142 are subject to further processing. In this embodiment, method 600, processing step 508 can include a metal leaching process 602 to remove some metals from the catalyst layer 112 of porous layers 142. In some embodiments, during processing step 508 the metal leaching process 602 can be followed by an annealing step 604. At step 510, the one or more porous layers 142, each formed of porous substrates 110 coated with the catalyst layer 112, are connected/coupled to each other to form the anode electrode 104 for the metal-hydrogen battery 100.

At leaching step 602 of step 504 , the porous layers 142 formed of porous substrates 110 coated with catalyst layers 112 may be soaked in an alkaline solution (e.g., a KOH solution) to selectively leach out some metal from the catalyst layers 112. This procedure results in a high surface area with a high density of active HOR/HER sites per unit area. In some embodiments, leaching may be performed at a temperature above room temperature, for example at about 30° C., 40° C., 50° C., 60° C., 70° C., 80° C., 90° C., or 100° C. or between any two of the above values, to accelerate the leaching procedure. In some embodiments, when the catalyst of catalyst layer 112 is a NiMoCo alloy, the leaching operation can remove a portion (but not all) of Mo from the NiMoCo alloy. Leaching of metals is not limited to high pH solutions and can be conducted across with solutions across the entire pH range (0-14) according to the solubility of the target metal. For example, Ni can be leached out in acidic solutions (pH<7) to provide an increased surface area. Leaching baths can also include an oxidizing or reducing agent to facilitate metal dissolution from a pure metal form or an alloy form. As further shown in FIG. 6, in some embodiments, leaching step 602 may be followed by an anneal step 604 where the porous layers are sent to an oven and annealed under a diluted hydrogen atmosphere to de-oxidize the surface. Annealing may be performed at similar temperatures to the leaching steps (e.g. at temperatures up to 100° C. or higher). In some embodiments, annealing step 604 can be performed under a diluted hydrogen atmosphere at temperatures of between 100° C. to 500° C., for example 400° C.

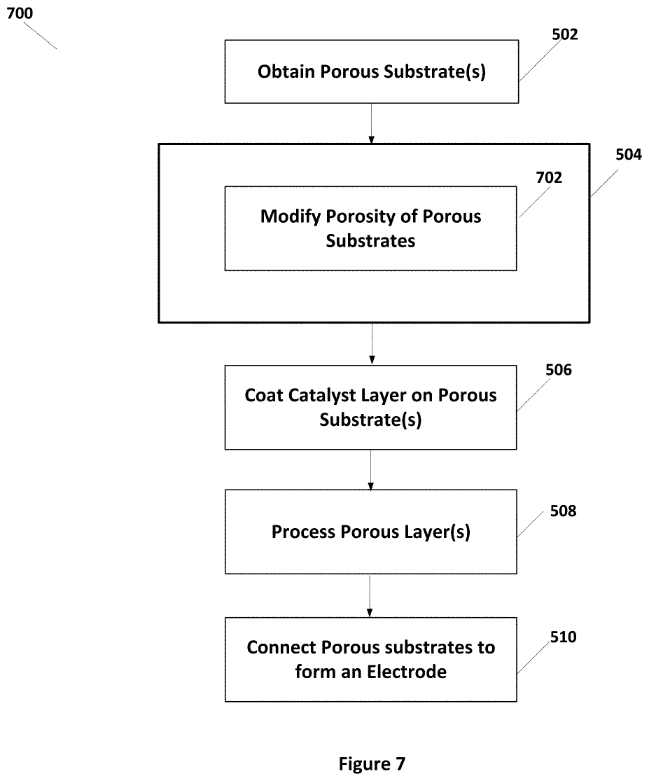

FIG. 7 depicts a method 700 that is another embodiment of method 500 for forming an anode electrode 104 for a metal-hydrogen battery 100 . As discussed above, at step 502, one or more porous substrates 110 are obtained. At step 504, each of the porous substrates 110 can be modified. In the example embodiment illustrated in FIG. 7, the porosity of at least some of the porous substrates 110 is modified in step 702. In step 506, porous substrates 110 are coated with a catalyst layer 112, for example by electroplating as discussed above. At step 508, the porous layers 142 formed from the porous substrates 110 coated with catalysis layers 112 can be subjected to further processing. As discussed above, at step 510, of the one or more porous layers 142 each formed of porous substrates 110 coated within the catalyst layer 112 are connected/coupled to each other to form anode electrode 104 for a metal-hydrogen battery 100 as discussed above.

In step 702 of processing step 504, in some embodiments, a porosity of one or more of the porous substrates 110 may be reduced, for example by compression of the porous susbstrate 110. For example, one or more porous substrates 110 that are received in step 502 to form the anode electrode 104 in step 510 may undergo a compression process to adjust their porosity. Compression may also provide more rigid porous substrates 110 for forming the anode electrode 104. In some embodiments, the porous substrates 110 may be compressed to different porosities, depending on the embodiment of the resulting anode electrode 104. Higher compressions applied to porous substrates result in lower porosity. For example, the porous substrates 110 that end up outermost in anode electrode 104 may be compressed to a greater degree than a porous substrate 110 that is located within the outermost porous substrates 110 of anode electrodes 104. In some embodiments, an interior porous substrate 110 may or may not undergo the compression process in step 702. This configuration, with higher compression on outer porosity layers 142 than on inner porosity layers, can produce rigidity on the exterior of the anode electrode 104 and provide a higher porosity portion in the interior of anode electrode 104 to facilitate fluid or gas flows for HER and HOR.

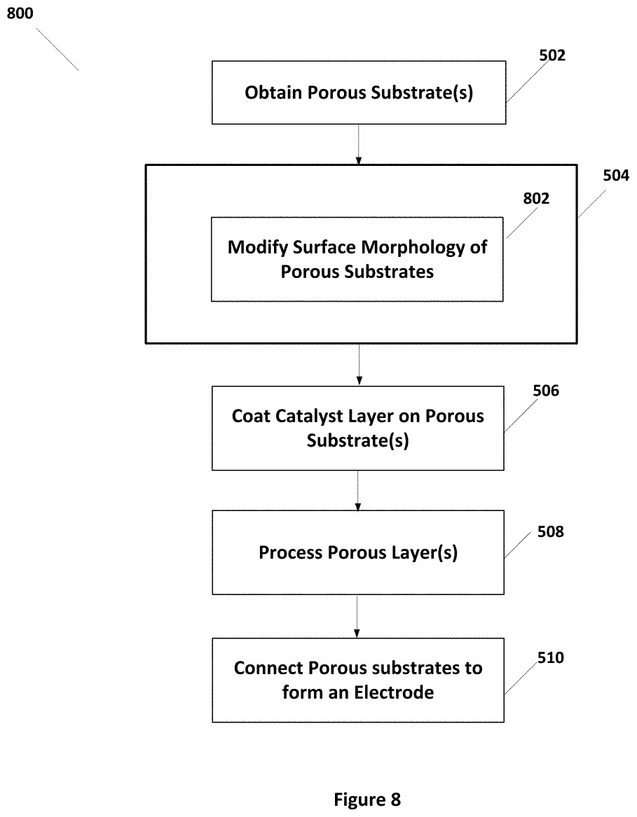

FIG. 8 depicts a method 800 that is another embodiment of method 500 for forming an anode electrode 104 for a metal-hydrogen battery 100. As discussed above, at step 502, one or more porous substrates 110 are obtained. At step 504, each of the porous substrates 110 can be modified. In the example embodiment illustrated in FIG. 8, the surface morphology of at least some of the porous substrates 110 is modified in step 802 to form surface features as discussed above. In step 506, porous substrates 110 are coated with a catalyst layer 112, for example by electroplating as discussed above, to form porous layers 142. At step 508, the porous layers 142 formed from the porous substrates 110 coated with catalysis layers 112 can be subjected to further processing. As discussed above, at step 510, of the one or more porous layers 142, each formed of porous substrates 110 coated within the catalyst layer 112, are connected/coupled to each other to form anode electrode 104 for a metal-hydrogen battery 100 as discussed above.

At surface modification step 802, the surface contour of one or more of the porous substrates 110 may be modified such that one or more channels (e.g., the channels 310 in FIGS. 3A-3C) can be formed at an interface of two adjacent porous layers 142. For example, one or more porous substrates 110 may be stamped on their surfaces to generate different surface morphologies, for example for two adjacent surfaces of two adjacent porous substrates 110. For example, one of the two adjacent is configured to be rough/uneven while another one of the two adjacent surface is configured to be smooth/flat. The surfaces of the porous substrates 110 may, for example, be any of a variety of shapes, such as wavy, corrugated, spiky, grooved, notched, rounded, or other shapes. Other methods that can be used to create the different surface morphologies include etching, cutting, scratching, or other methods to form the surface morphology. In some embodiments, morphology step 802 and porosity step 702 may be combined into a single pressing or stamping step that results in formation of the surface morphology as well as adjusting the porosity of the porous substrate 110.

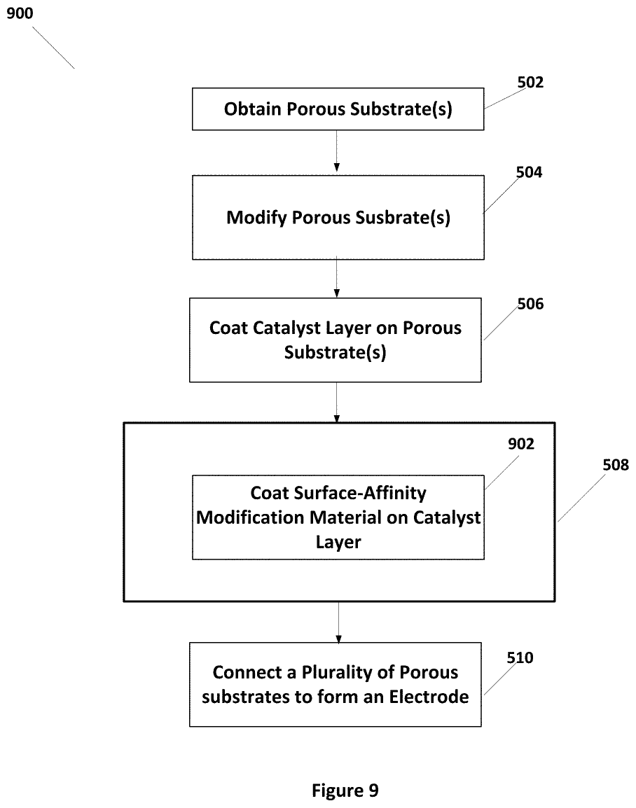

FIG. 9 depicts a method 900 that is another embodiment of method 500 for forming a anode electrode 104 for a metal-hydrogen battery 100. As discussed above, at step 502, one or more porous substrates 110 are obtained. At step 504, each of the porous substrates 110 can be modified. In step 506, porous substrates 110 are coated with a catalyst layer 112, for example by electroplating as discussed above, to form porous layers 142. At step 508, The porous layers 142 formed from the porous substrates 110 coated with catalysis layers 112 can be subjected to further processing. As illustrated in FIG. 9, step 508 may include a surface-affinity coating step 902, as is discussed further below. As discussed above, at step 510, of the one or more porous layers 142, each formed of porous substrates 110 coated within the catalyst layer 112, are connected/coupled to each other to form anode electrode 104 for a metal-hydrogen battery 100 as discussed above. At step 902 of step 508, a surface-affinity modification material is coated on the catalyst layers.

At step 902, in some embodiments, when the catalyst layers 112 on the porous substrates 111 are hydrophilic with respect to the electrolyte, the catalyst layers 112 may be partially coated with a material that is hydrophobic with respect to the electrolyte 108. In some embodiments, when the catalyst layers 112 on the porous substrates 110 are hydrophobic with respect to the electrolyte, the catalyst layers 112 may be partially coated with a material that is hydrophilic with respect to the electrolyte 108. The resulting structure can facilitate movement of hydrogen gas in the pores of the porous layers 142 of anode electrode 104 and avoid anode flooding. In some embodiments, the surface-affinity modification material that is coated in step 902 may be a polymer or polymers. As a non-limiting example, the surface-affinity modification material can include hydrophobic polymer such as PTFE, as discussed above.

It should be understood that the methods disclosed herein may be modified or combined partially or entirely to make the electrodes suitable for use in metal-hydrogen batteries. In particular, method 500 may include any combination of processes as discussed in each of FIGS. 6-9 above. Specific examples are given below to illustrate further methods for forming an anode electrode 104 for metal-hydrogen batteries 100.

### EXAMPLE I: INCREASING ACTIVE HOR/HER SITES ON THE SURFACE OF ELECTRODE

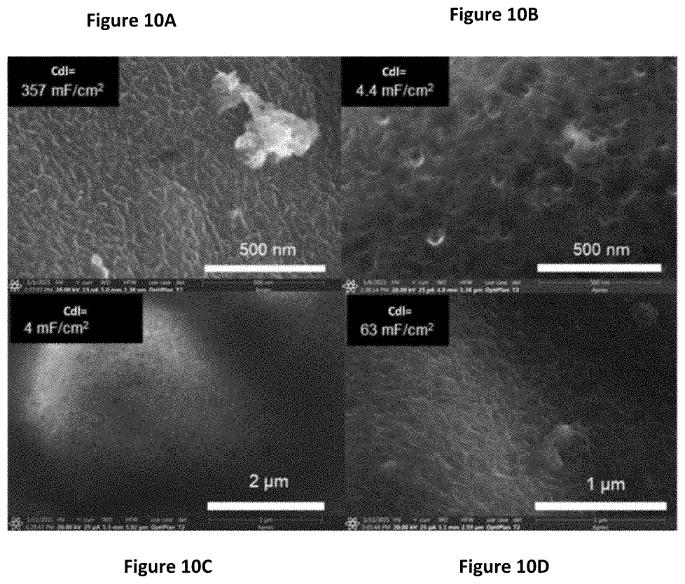

In some embodiments, in step 506 electrodeposition of a NiMoCo alloy on a porous electrode 110 can be used to form catalyst layer 112. In these embodiments, the resulting porous layer 142, with the porous substrate 110 and catalyst layer 112, can be soaked in a concentrated KOH solution to selectively leach out some of the Mo in step 602 as is illustrated in FIG. 6. This process can result in a high surface area with a high density of active HOR/HER sites per unit area. A robust electrochemical impedance process is developed to estimate the surface area from the double layer capacitance (C_{dl}) that can be further evaluated using electron microscopy. FIGS. 10A-D are scanning electron microscopic (SEM) images showing that surfaces with higher C_{dl} values have rougher surfaces. The Cal values correlate very strongly with the charge transfer resistance (Rct) for HOR/HER and can be used to quickly screen quality of batches of porous layers.

### EXAMPLE II: ELECTROPLATING BATH COMPOSITION

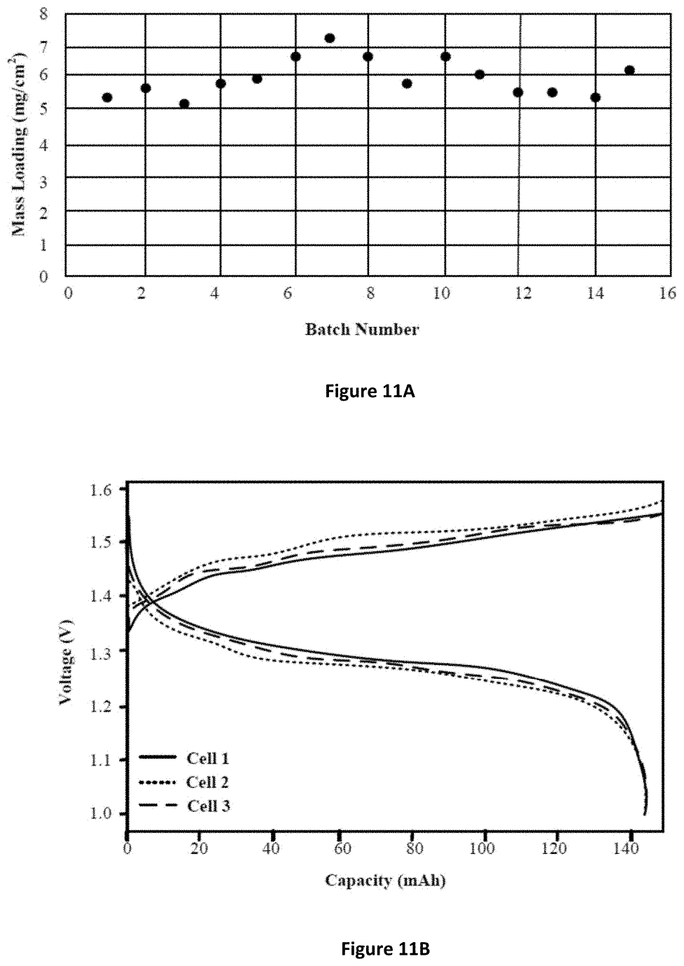

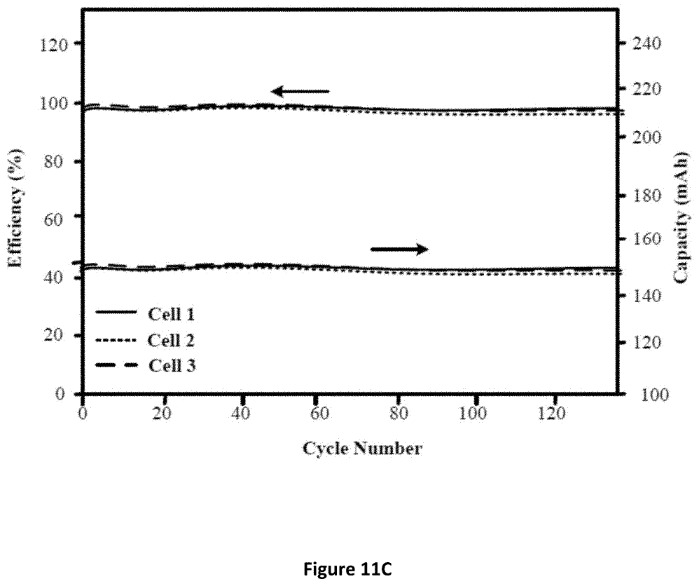

The bath composition that can be used for electroplating catalysts in step 506 can be modified by increasing the metal ion concentrations by a factor of two to five. Such an increase in metal ion concentrations increases catalyst loading and performance. The higher metal concentration metal ions can be used for many plating runs to be carried out before the bath needs to be replenished. FIG. 11A shows mass loading in mg/cm² versus batch number and illustrates consistent catalyst loading achieved by an increased metal concentration without needing to replenish the bath as frequently. Battery cells made using this re-designed bath also showed strong performance. FIG. 11B illustrates a graph of voltage vs. capacity for several cells (cells 1, 2, and 3), each formed with a pair of cathode electrode 102 and anode electrode 104 formed according to embodiments of the present disclosure. FIG. 11C illustrates efficiency and capacity vs. cycle number for the three cells illustrated in FIG. 11B. Both FIGS. 11B and 11C illustrate strong performance using the suggested bath composition.

### EXAMPLE III: MO LEACHING FROM NIMOCO CATALYST

The Mo leaching process step 602 as described above can be performed in concentrated KOH on porous layers post-electroplating of a NiMoCo catalyst layer 112 onto porous substrate 110 to increase active reaction sites on the surface area. Leaching process step 602 takes a longer time at room temperature than it does at elevated temperatures. Alternatively, step 602 may utilize an etching process. The same catalytic surface area and performance as achieved with concentrated KOH can be achieved by etching at elevated temperatures for short time, for example as short as 30 min.

### EXAMPLE IV: THREE-LAYER ELECTRODE STRUCTURE

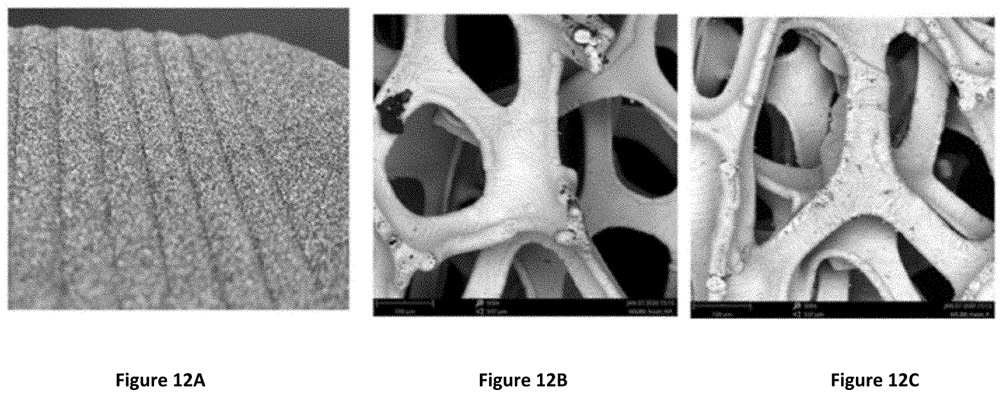

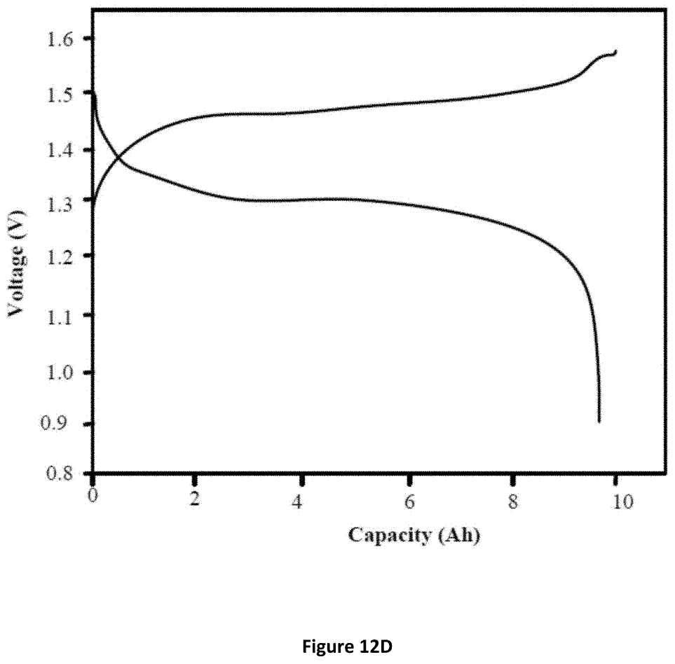

A three-layer anode structure such as that illustrated in FIG. 3C above allows for a high density of catalyst sites and facile hydrogen gas transport without the need for a gas screen. As described above, the anode electrode 104 includes three porous layers (layer 322, 324, and 326) stacking together. Hydrogen flow channels are created by corrugating the middle layer 326 of the three porous substrates. FIG. 12A is an image showing an example of the corrugated middle layer, layer 326. FIG. 12B is an SEM image showing a porous substrate before compression in the porosity modification step 702 of FIG. 7; FIG. 12C is an SEM image showing a porous substrate 110 after compression in the porosity modification step 702 of FIG. 7. FIG. 12C also shows that a compressed porous substrate has a reduced porosity. FIG. 12D is a diagram illustrating voltage-capacity curves for a 10 Ah battery using the three-layer anode electrode 104 as illustrated in FIG. 3C, demonstrating strong performance while using the three-layer anode electrodes 104.

### EXAMPLE V: WET-PROOFING ANODE USING PTFE

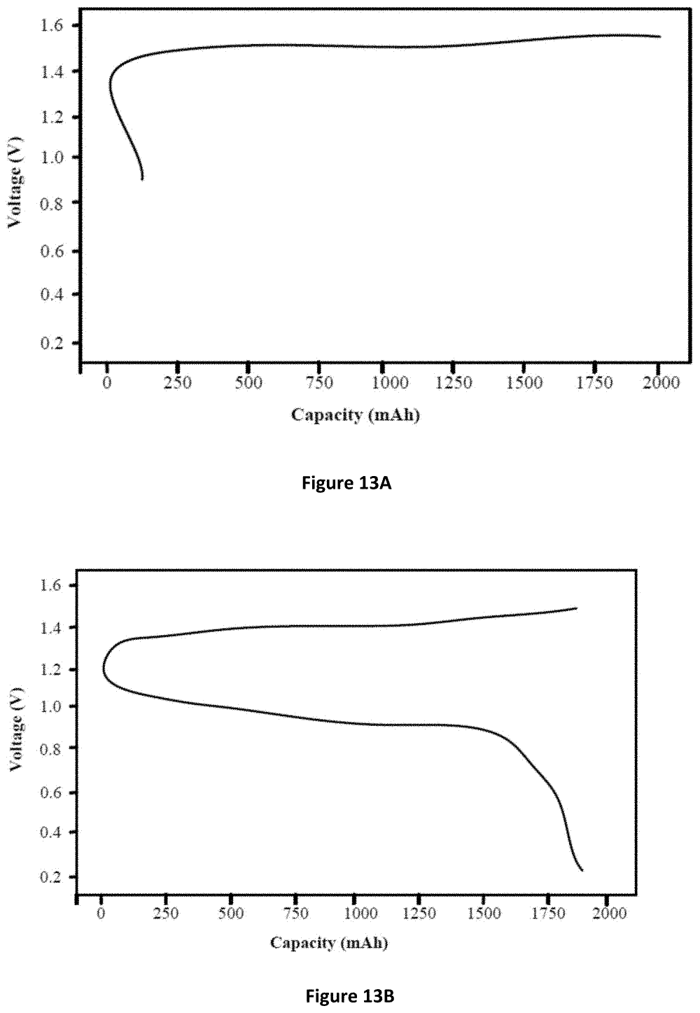

Affinity coating step 902 of processing step 508 as illustrated in FIG. 9 can be performed with a dipping and sintering process to induce hydrophobic sites on an anode porous layer 142 to create an optimal balance between electrolyte permeation and hydrogen gas transport without causing anode flooding. FIG. 13A is a diagram of voltage vs. capacity showing that a battery cell without a wet-proofing (affinity) coating struggles to discharge because of anode flooding. Consequently, the resulting battery struggles to discharge because of anode flooding with electrolyte 108, which suppresses HOR reaction by blocking hydrogen gas accessing to electrode surfaces. FIG. 13B is a diagram of voltage vs. capacity showing that a battery cell where anode porous layers 142 include a wet-proofing coating (e.g., fluoropolymer) exhibits significantly improved discharge characteristics over that of the battery cell shown in FIG. 13A.

### EXAMPLE VI: STABLE CELL PERFORMANCE AT HIGH TEMPERATURE

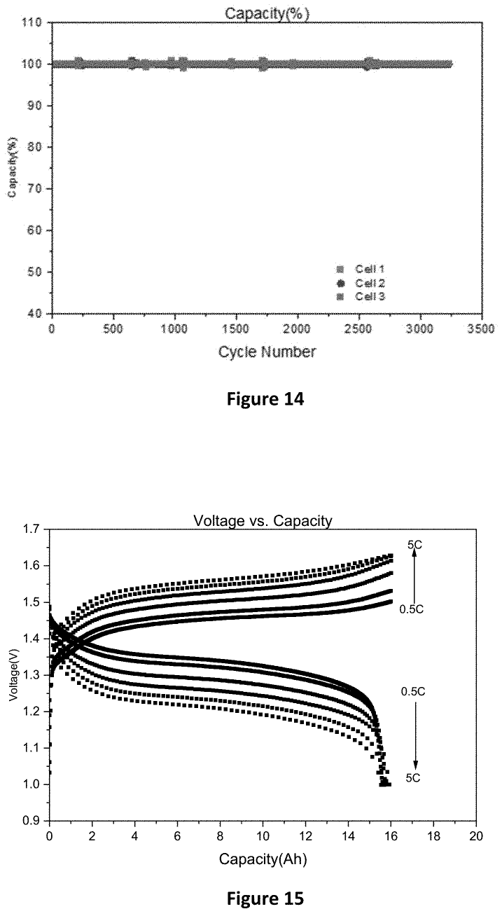

FIG. 14 shows an example battery with one of three cells. Each cell includes an anode electrode 104 with a single layer structure such as that illustrated in FIG. 2. As illustrated in FIG. 14, each of the cells can stably cycle at charging rates of 0.5 C at 45° C. for more than 3000 cycles with stable performance.

### EXAMPLE VII: HIGH C RATE PERFORMANCE

FIG. 15 shows a 16 Ah cell with three layer structure anode electrode 104 such as that illustrated in FIG. 3C. FIG. 15 illustrates that the embodiments of battery 100 using anode electrodes 104 as described above can easily run reliably at charging and discharging rates of up to 5 C without any capacity loss.

### EXAMPLE VIII: STABLE 2 C CYCLING PERFORMANCE AT ROOM TEMPERATURE

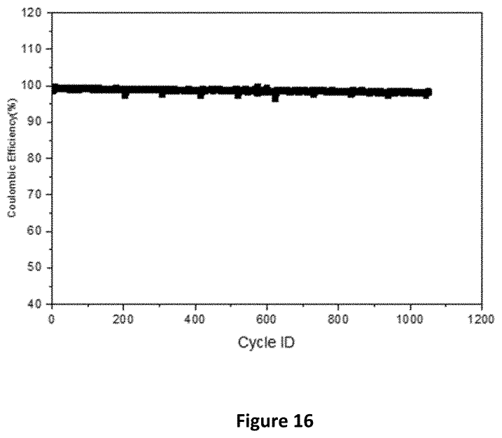

FIG. 16 shows a 20 Ah cell with double layer structure anode electrode 104 such as that illustrated in FIG. 3A that can cycle at charging rates of 2 C or more for more than 1000 cycles with stable cell performance.

### Aspects of the Disclosure

Aspects of the present disclosure describe electrodes incorporated with a metal hydrogen battery and their formation. A selection of the multitude of aspects of the present disclosure can include the following aspects:

Aspect 1: An electrode for a metal-hydrogen battery, the electrode comprising: one or more porous layers, each of the porous layers including a porous substrate and a catalyst layer covering the porous substrate, the catalyst layer including a transition metal, wherein at least one of the at least one porous layer includes a surface with features that facilitate hydrogen gas transport.

Aspect 2: The electrode of Aspect 1, wherein the at least one porous layer includes a plurality of porous layers, wherein a first surface of a first porous layer and a second surface with features of a second porous layer have contours that form hydrogen gas transport channels.

Aspect 3: The electrode of Aspects 1-2, wherein the porous substrate of each of the at least one porous layer includes one or more of a metal or metal alloy foam, metal foil, metal mesh, fibrous conductive substrate, carbon fibrous paper, carbon cloth, carbon felt, carbon mat, carbon nanotube film, graphite foil, graphite foam, graphite mat, graphene foil, graphene fibers, graphene film, and graphene foam.

Aspect 4: The electrode of Aspects 1-3, wherein the metal or metal alloy foam is one of a nickel foam, nickel-molybdenum foam, nickel-iron foam, nickel-copper foam, nickel-cobalt foam, nickel tungsten foam, nickel-silver foam, and nickel-molybdenum-cobalt foam.

Aspect 5: The electrode of Aspects 1-4, wherein the porous substrate of each of the at least one porous layer includes the metal foam or the metal alloy foam.

Aspect 6: The electrode of Aspects 1-5, wherein the catalyst layer is a bi-functional catalyst that contributes both to hydrogen evolution reaction (HER) and hydrogen oxidation reaction (HOR).

Aspect 7: The electrode of Aspects 1-6, wherein the bi-functional catalyst is one or more of nickel-molybdenum-cobalt (NiMoCo), nickel, nickel-molybdenum, nickel-tungsten, nickel-tungsten-cobalt, nickel-tungsten-copper, nickel-carbon, and nickel-chromium.

Aspect 8: The electrode of Aspects 1-7, wherein the transition metal of the bi-functional catalyst includes two or more of Ni, Co, Cr, Mo, Fe, Zn, Sn, and W.

Aspect 9: The electrode of Aspects 1-8, wherein the bi-functional catalyst includes one or more of platinum, palladium, iridium, gold, rhodium, ruthenium, rhenium, osmium, silver, nickel, cobalt, manganese, iron, molybdenum, tungsten, and chromium.

Aspect 10: The electrode of Aspects 1-9, wherein the transition metal alloy is a NiMoCo alloy or a NiMo alloy.

Aspect 11: The electrode of Aspects 1-10, wherein the at least one porous layer includes a first porous layer, a second porous layer, and a third porous layer disposed between the first porous layer and the second layer, and wherein the third porous layer has a first surface contour different from a second surface contour of the first porous layer or the second porous layer.

Aspect 12: The electrode of Aspects 1-11, wherein the features include one or more of corrugation, notches, rounded hills and/or valleys, and grooves.

Aspect 13: The electrode of Aspects 1-12, wherein at least one of the catalyst layers of the first porous layer, the second porous layer, and the third porous layer is at least partially coated with a wet-proofing material.

Aspect 14: The electrode of Aspects 1-13, wherein the wet-proofing material includes one of polyethylene, polyprophylene, partial or fully fluorinated polymers, polytetrafluoroethylene (PTFE), fluorinated ethylene propylene (FEB), polyethylenetetrafluoroethylene (ETFE), polyvinylfluoride (PVF), and polyvinylidene fluoride (PVDF).

Aspect 15: An anode electrode, comprising: a first porous layer having a first surface; and a second porous layer adjacent the first porous layer having a second surface, wherein the first surface of the first porous layer and the second surface of the second porous layer form hydrogen gas transport channels.

Aspect 16: The anode electrode of Aspect 15, wherein the first surface is flat or smooth and the second surface includes uneven features.

Aspect 17: The anode electrode of Aspects 15-16, wherein one or both of the first surface and the second surface includes uneven features.

Aspect 18: The anode electrode of Aspects 15-17, wherein the uneven features of the first surface or the second surface include one or more of corrugation, notches, rounded hills and/or valleys, and grooves.

Aspect 19: The anode electrode of Aspects 15-18, wherein the second porous layer has a third surface opposite the second surface, and further including a third porous layer having a fourth surface, wherein the fourth surface of the third porous layer and the third surface of the second porous layer form second transport channels.

Aspect 20: A battery, comprising: a pressure vessel; and an electrode stack positioned in the pressure vessel, the electrode stack holding electrolyte, wherein the electrode stack includes alternately stacked cathode electrodes and anode electrodes separated by a separators, the anode electrode including one or more porous layers, each of the porous layers including a porous substrate and a catalyst layer covering the porous substrate, the catalyst layer including a transition metal, wherein at least one of the at least one porous layer includes a surface with features that facilitate hydrogen gas transport.

Aspect 21: A method for forming an electrode for a metal-hydrogen battery, the method comprising: obtaining one or more porous substrates; forming surface features in at least one surface of at least one of the porous substrates; coating the one or more porous substrates with a catalyst layer to form porous layers; and connecting the porous layers to form the electrode.

Aspect 22: The method of Aspect 21, wherein coating the one or more porous substrates with the catalyst layer includes electroplating the porous substrates with the catalyst layer, wherein the catalyst layer includes a transition metal alloy.

Aspect 23: The method of Aspects 21-22, wherein electroplating the porous substrate with the catalyst layer is performed in a bath containing two or more of Ni, Co, Cr, Mo, Fe, Zn, S, and W.

Aspect 24: The method of Aspects 21-23, further comprising leaching the porous layers to remove some metal from the catalytic layers.

Aspect 25: The method of Aspects 21-24, wherein the transition metal alloy includes Mo and wherein leaching includes removing Mo from the porous layers.

Aspect 26: The method of Aspects 21-25, wherein leaching includes immersion of the porous layers in an alkaline solution that includes KOH.

Aspect 27: The method of Aspects 21-26, wherein the leaching is performed at a temperature above the room temperature.

Aspect 28: The method of Aspects 21-27, wherein the temperature is about 40° C. to about 80° C.

Aspect 29: The method of Aspects 21-28, further including an annealing step following the leaching step.

Aspect 30: The method of Aspects 21-29, wherein the annealing step includes annealing in an oven under a diluted hydrogen atmosphere at temperatures between 100° C. and 500° C.

Aspect 31: The method of Aspects 21-30, wherein forming surface features includes forming one of corrugation, notches, rounded hills and/or valleys, and grooves.

Aspect 32: The method of Aspects 21-31, further including modifying a porosity of the porous substrate of at least one of the porous substrates.

Aspect 33: The method of Aspects 21-32, further including coating at least one of the porous layers with a surface affinity modification material to provide wet proofing.

Aspect 34: The method of Aspects 21-33, wherein connecting the porous layers to form the electrode includes stacking a first porous layer and a second porous layer such that the surface features form first transport channels between the first porous layer and the second porous layer for the transportation of hydrogen gas.

Aspect 35: The method of Aspects 21-34, further including further stacking a third porous layer with the second porous layer to form second transport channels between the second porous layer and the third porous layer.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. An electrode for a metal-hydrogen battery, the electrode comprising:
one or more porous layers, each of the porous layers including a porous substrate and a catalyst layer covering the porous substrate, the catalyst layer including a transition metal,
wherein at least one of the at least one porous layer includes a surface with features that facilitate hydrogen gas transport.

2. The electrode of claim 1, wherein the at least one porous layer includes a plurality of porous layers, wherein a first surface of a first porous layer and a second surface with features of a second porous layer have contours that form hydrogen gas transport channels.

3. The electrode of claim 1, wherein the porous substrate of each of the at least one porous layer includes one or more of a metal or metal alloy foam, metal foil, metal mesh, fibrous conductive substrate, carbon fibrous paper, carbon cloth, carbon felt, carbon mat, carbon nanotube film, graphite foil, graphite foam, graphite mat, graphene foil, graphene fibers, graphene film, and graphene foam.

4. The electrode of claim 3, wherein the metal or metal alloy foam is one of a nickel foam, nickel-molybdenum foam, nickel-iron foam, nickel-copper foam, nickel-cobalt foam, nickel tungsten foam, nickel-silver foam, and nickel-molybdenum-cobalt foam.

5. The electrode of claim 3, wherein the porous substrate of each of the at least one porous layer includes the metal foam or the metal alloy foam.

6. The electrode of claim 1, wherein the catalyst layer is a bi-functional catalyst that contributes both to hydrogen evolution reaction (HER) and hydrogen oxidation reaction (HOR).

7. The electrode of claim 6, wherein the bi-functional catalyst is one or more of nickel-molybdenum-cobalt (NiMoCo), nickel, nickel-molybdenum, nickel-tungsten, nickel-tungsten-cobalt, nickel-tungsten-copper, nickel-carbon, and nickel-chromium.

8. The electrode of claim 6, wherein the transition metal of the bi-functional catalyst includes two or more of Ni, Co, Cr, Mo, Fe, Zn, Sn, and W.

9. The electrode of claim 6, wherein the bi-functional catalyst includes one or more of platinum, palladium, iridium, gold, rhodium, ruthenium, rhenium, osmium, silver, nickel, cobalt, manganese, iron, molybdenum, tungsten, and chromium.

10. The electrode of claim 8, wherein the transition metal alloy is a NiMoCo alloy or a NiMo alloy.

11. The electrode of claim 1, wherein the at least one porous layer includes a first porous layer, a second porous layer, and a third porous layer disposed between the first porous layer and the second layer, and wherein the third porous layer has a first surface contour different from a second surface contour of the first porous layer or the second porous layer.

12. The electrode of claim 11, wherein the features include one or more of corrugation, notches, rounded hills and/or valleys, and grooves.

13. The electrode of claim 1, wherein at least one of the catalyst layers of the first porous layer, the second porous layer, and the third porous layer is at least partially coated with a wet-proofing material.

14. The electrode of claim 13, wherein the wet-proofing material includes one of polyethylene, polyprophylene, partial or fully fluorinated polymers, polytetrafluoroethylene (PTFE), fluorinated ethylene propylene (FEB), polyethylenetetrafluoroethylene (ETFE), polyvinylfluoride (PVF), and polyvinylidene fluoride (PVDF).

15. An anode electrode, comprising:
a first porous layer having a first surface; and
a second porous layer adjacent the first porous layer having a second surface,
wherein the first surface of the first porous layer and the second surface of the second porous layer form hydrogen gas transport channels.

16. The anode electrode of claim 15, wherein the first surface is flat or smooth and the second surface includes uneven features.

17. The anode electrode of claim 15, wherein one or both of the first surface and the second surface includes uneven features.

18. The anode electrode of claim 17, wherein the uneven features of the first surface or the second surface include one or more of corrugation, notches, rounded hills and/or valleys, and grooves.

19. The anode electrode of claim 15, wherein the second porous layer has a third surface opposite the second surface, and further including a third porous layer having a fourth surface, wherein the fourth surface of the third porous layer and the third surface of the second porous layer form second transport channels.

20. A battery, comprising:
a pressure vessel; and
an electrode stack positioned in the pressure vessel, the electrode stack holding electrolyte,
wherein the electrode stack includes alternately stacked cathode electrodes and anode electrodes separated by a separators, the anode electrode including
one or more porous layers, each of the porous layers including a porous substrate and a catalyst layer covering the porous substrate, the catalyst layer including a transition metal,
wherein at least one of the at least one porous layer includes a surface with features that facilitate hydrogen gas transport.

21. A method for forming an electrode for a metal-hydrogen battery, the method comprising:
obtaining one or more porous substrates;
forming surface features in at least one surface of at least one of the porous substrates;
coating the one or more porous substrates with a catalyst layer to form porous layers; and
connecting the porous layers to form the electrode.

22. The method of claim 21, wherein coating the one or more porous substrates with the catalyst layer includes electroplating the porous substrates with the catalyst layer, wherein the catalyst layer includes a transition metal alloy.

23. The method of claim 22, wherein electroplating the porous substrate with the catalyst layer is performed in a bath containing two or more of Ni, Co, Cr, Mo, Fe, Zn, S, and W.

24. The method of claim 21, further comprising leaching the porous layers to remove some metal from the catalytic layers.

25. The method of claim 24, wherein the transition metal alloy includes Mo and wherein leaching includes removing Mo from the porous layers.

26. The method of claim 24, wherein leaching includes immersion of the porous layers in an alkaline solution that includes KOH.

27. The method of claim 26, wherein the leaching is performed at a temperature above the room temperature.

28. The method of claim 27, wherein the temperature is about 40° C. to about 80° C.

29. The method of claim 24, further including an annealing step following the leaching step.

30. The method of claim 29, wherein the annealing step includes annealing in an oven under a diluted hydrogen atmosphere at temperatures between 100° C. and 500° C.

31. The method of claim 21, wherein forming surface features includes forming one of corrugation, notches, rounded hills and/or valleys, and grooves.

32. The method of claim 21, further including modifying a porosity of the porous substrate of at least one of the porous substrates.

33. The method of claim 21, further including coating at least one of the porous layers with a surface affinity modification material to provide wet proofing.

34. The method of claim 21, wherein connecting the porous layers to form the electrode includes stacking a first porous layer and a second porous layer such that the surface features form first transport channels between the first porous layer and the second porous layer for the transportation of hydrogen gas.

35. The method of claim 34, further including further stacking a third porous layer with the second porous layer to form second transport channels between the second porous layer and the third porous layer.
